(19) United States
(12) Patent Application Publication
(10) Pub. No.: US 2024/0174810 A1
(43) Pub. Date: May 30, 2024

(54) MODIFIED MALEIMIDE RESIN

(71) Applicant: NAN YA PLASTICS CORPORATION, TAIPEI (TW)

(72) Inventors: Te-Chao Liao, TAIPEI (TW); Yu-Ting Liu, TAIPEI (TW); Hung-Yi Chang, TAIPEI (TW); Chi-Lin Chen, TAIPEI (TW)

(73) Assignee: NAN YA PLASTICS CORPORATION, TAIPEI (TW)

(21) Appl. No.: 18/072,630

(22) Filed: Nov. 30, 2022

(30) Foreign Application Priority Data
Nov. 3, 2022 (TW) 111141999

(51) Int. Cl. C08G 73/10

(52) U.S. Cl. CPC C08G 73/1067

(57) ABSTRACT

A modified maleimide resin is provided. The modified maleimide resin is formed from a dicyclopentadiene (DCPD)-based resin having an amino group and a maleic anhydride by a condensation polymerization. The dicyclopentadiene-based resin having an amino group is formed by nitration and hydrogenation of dicyclopentadiene phenolic resin.

### CROSS-REFERENCE TO RELATED APPLICATION

This application claims the priority benefit of Taiwan application serial no. 111141999, filed on Nov. 3, 2022. The entirety of the above-mentioned patent application is hereby incorporated by reference herein and made a part of this specification.

### BACKGROUND

### Technical Field

The invention relates to a maleimide resin, particularly to a modified maleimide resin.

### Description of Related Art

Bismaleimide resins have good heat resistance, moisture resistance, dielectric constant (Dk) and dissipation factor (Df) and other characteristics, so it is usually applied in insulating materials of high-frequency printed circuit boards and other electronic substrates. However, the dielectric properties of the currently used bismaleimide resins limit their application to electronic products based on 5th generation mobile networks (5G).

### SUMMARY

The invention provides a modified maleimide resin capable of providing good dielectric properties and heat resistance.

A modified maleimide resin of the invention is formed from a dicyclopentadiene (DCPD)-based resin having an amino group and a maleic anhydride by a condensation polymerization. The dicyclopentadiene-based resin having an amino group is formed by nitration and hydrogenation of dicyclopentadiene phenolic resin.

In an embodiment of the invention, an equivalent ratio of a mole number of the amino group of the dicyclopentadiene-based resin having an amino group to a mole number of a maleic anhydride group of the maleic anhydride is 1:1 to 1:10.

In an embodiment of the invention, a weight average molecular weight of the modified maleimide resin is 800 to 10,000.

A modified maleimide resin of the invention has a structure represented by Formula (1) as follows:

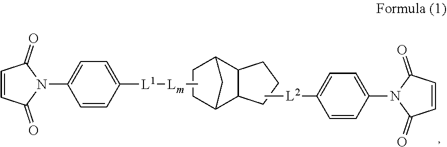

in Formula (1), L represents a dicyclopentadienylene group, a divalent organic group derived from a phenol-based compound or a combination thereof,

L¹ and L² each represent a divalent organic group derived from a phenol-based compound, and,

m represents an integer from 0 to 18.

In an embodiment of the invention, the phenol-based compound includes phenol.

In an embodiment of the invention, the L represents

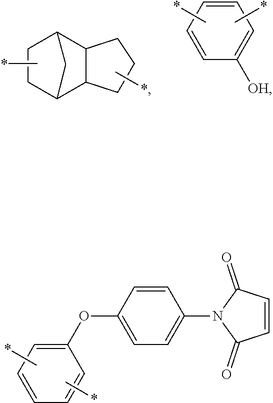

or a combination thereof, and * represents a bonding position.

In an embodiment of the invention, the L¹ and L² each represent

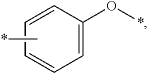

and * represents a bonding position.

Based on the above, the invention provides a maleimide resin whose main chain includes a dicyclopentadiene structure (dicyclopentadiene maleimide (DCPD-MI)), which has good dielectric properties and heat resistance.

To make the features and advantages of the disclosure to be comprehended more easily, embodiments are described in detail as follows.

### DESCRIPTION OF THE EMBODIMENTS

The following are embodiments describing the content of the invention in detail. The implementation details provided in the embodiments are for illustrative purposes, and are not intended to limit the scope of protection of the content of the invention. Those with ordinary knowledge in the art may modify or change these implementation details according to the needs of the actual implementation.

The “divalent organic group” as used in the specification is an organic group having two bonding positions. And the “divalent organic group” may form two chemical bonds through these two bonding positions.

The invention provides a modified maleimide resin formed from a dicyclopentadiene-based resin having an amino group and a maleic anhydride by a condensation polymerization, wherein the dicyclopentadiene-based resin having an amino group is formed by nitration and hydrogenation of dicyclopentadiene phenolic resin.

Thus, the modified maleimide resin of the invention has a structure in which the main chain includes dicyclopentadiene, which makes the modified maleimide resin have good dielectric properties and heat resistance.

Specific examples of commercially available products of dicyclopentadiene resin having a phenol group may include ERM6140 (trade name; manufactured by Songwon Industrial Co., Ltd.; weight average molecular weight: 1,300), ERM6105 (trade name; manufactured by Songwon Industrial Co., Ltd.; weight average molecular weight: 800), ERM6115 (trade name; manufactured by Songwon Industrial Co., Ltd.; weight average molecular weight: 1,100) or other suitable dicyclopentadiene phenolic resin.

### <Preparation Method of Modified Maleimide Resin>

First, the dicyclopentadiene-based resin having an amino group is formed by performing a dicyclopentadiene phenolic resin to nitration and hydrogenation. The method of nitration and hydrogenation of the dicyclopentadiene phenolic resin is not particularly limited, for example, well-known nitration and hydrogenation may be performed, which will not be described in detail here. Next, the dicyclopentadiene-based resin having an amino group and the maleic anhydride are performed to a condensation polymerization to form a modified maleimide resin. In this embodiment, an equivalent ratio of a mole number of the amino group of the dicyclopentadiene-based resin having an amino group to a mole number of a maleic anhydride group of the maleic anhydride is 1:1 to 1:10, preferably 1:1 to 1:3.

The modified maleimide resin has a structure represented by Formula (1) as follows. In this embodiment, a weight average molecular weight of the modified maleimide resin is 800 to 10,000, preferably 1,000 to 4,000.

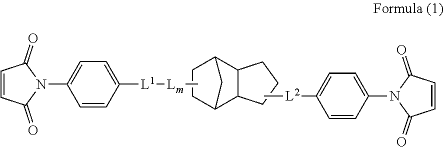

In Formula (1), L represents a dicyclopentadienylene group, a divalent organic group derived from a phenol-based compound or a combination thereof, preferably a combination of the dicyclopentadienylene group and the divalent organic group derived from the phenol-based compound, and the divalent group is preferably a divalent group including a maleimide group;

L¹ and L² each represent a divalent organic group derived from a phenol-based compound; and

m represents an integer from 0 to 18, preferably an integer from 2 to 10.

L, L¹ and L² may represent a divalent group derived from phenol. In this embodiment, L may represent

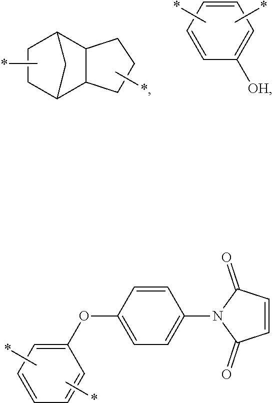

or a combination thereof, preferably a combination of

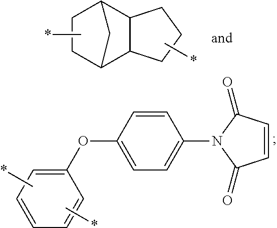

* represents a bonding position. L¹ and L² may each represent

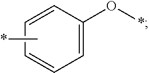

* represents a bonding position.

In this embodiment, the modified maleimide resin has a structure represented by Formula (2) as follows. In this embodiment, the modified maleimide resin is a modified multi-maleimide resin.

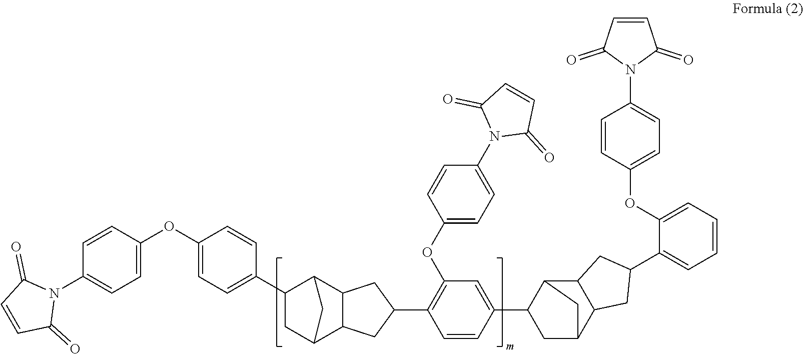

In formula (2), m represents an integer from 0 to 18, preferably an integer from 2 to 10.

### Examples of Modified Maleimide Resin

Example 1 and Comparative example 1 of the modified maleimide resin are described below:

### Example 1

Dicyclopentadiene phenolic resin including 1 mole hydroxyl group (trade name: ERM6140, manufactured by Songwon Industrial Co., Ltd.; weight average molecular weight: 1,300) and 1.25 mole of 4-halonitrobenzene (halogen may be fluorine, chlorine, bromine or iodine) were added in 6 mole of dimethylacetamide (DMAC) as a reaction solvent, and reacted at a temperature of 120° C. for 300 minutes to perform a nitration reaction. Next, hydrogen gas was inserted thereto, and reacted at a temperature of 90° C. for 480 minutes to perform a hydrogenation reaction to form a dicyclopentadiene-based resin having an amino group. Next, 3 mol of maleic anhydride and 9.7 wt % of methylbenzenesulfonic acid were added thereto, and reacted at a temperature of 120° C. for 420 minutes. The modified maleimide resin of Example 1 was obtained, which is a maleimide resin whose main chain includes a dicyclopentadiene structure (DCPD-MI) and has a structure represented by Formula (2) (m representing an integer from 0 to 18). The obtained modified maleimide resin was evaluated by each of the following evaluation methods, and the results thereof are as shown in Table 1.

### Comparative Example 1

The maleimide resin of Comparative example 1 is a commercially available bismaleimide resin BMI-KI-70 (trade name; manufactured by KI CHEMICAL INDUSTRY CO. LTD; weight average molecular weight: 443). It was evaluated by each of the following evaluation methods, and the results thereof are as shown in Table 1.

TABLE 1

| | Example 1 | Comparative example 1 |
|---|---|---|
| Maleimide resin | DCPD-MI | BMI-KI-70 |
| Tg (unit: ° C.) | 212 | 204 |
| Peel strength (unit: lb/in) | 6.9 | 6.2 |
| Water absorption (unit: %) | 0.28 | 0.36 |
| Dielectric constant (Dk) | 3.1 | 3.3 |
| Dissipation factor (Df) | 0.0023 | 0.0033 |

### <Evaluation Methods>

a. Glass Transition Temperature (Tg)

The prepared modified maleimide resin was measured for a glass transition temperature (Tg) via a dynamic mechanical analyzer (DMA). When the Tg is greater, the modified maleimide resin has good resistance to phase changes, that is, good heat resistance.

Heating rate: 10° C./min

Temperature range: 30° C. to 300° C. (heating, cooling, heating)

b. Peel Strength

The prepared modified maleimide resin was coated on a substrate, and baked at a temperature of 120° C. for 2 minutes to form a resin film. Then, copper foils were laminated on an upper surface and a lower surface of the resin film, and hot pressed at a temperature of 210° C. for 3 hours to form a film with thickness of 200 μm. Next, the film was measured for a peel strength via a universal tensile machine. When the peel strength is greater, the modified maleimide resin has good resistance to peeling from the substrate, that is, good peel resistance.

c. Water Absorption

The prepared modified maleimide resin was placed in a constant temperature and humidity box, and the water absorption was measured when the temperature reached 85° C. and the humidity reached 85%. When the water absorption is smaller, the modified maleimide resin has good moisture resistance.

d. Dielectric Constant (Dk)

The prepared modified maleimide resin was coated on a substrate, and baked at a temperature of 120° C. for 2 minutes, and then hot pressed at a temperature of 210° C. for 3 hours to form a film with thickness of 100 μm. Next, the film was measured for a dielectric constant (Dk) at a frequency of 10 GHz via a dielectric analyzer (model: E4991A; manufactured by Agilent Technologies, Inc.). When the dielectric constant is smaller, the modified maleimide resin has good dielectric property.

e. Dissipation Factor (Df)

The prepared modified maleimide resin was coated on a substrate, and baked at a temperature of 120° C. for 2 minutes, and then hot pressed at a temperature of 210° C. for 3 hours to form a film with thickness of 100 μm. Next, the film was measured for a dissipation factor (Df) at a frequency of 10 GHz via a dielectric analyzer (model: E4991A; manufactured by Agilent Technologies, Inc.). When the dissipation factor is smaller, the modified maleimide resin has good dielectric property.

### <Evaluation Results>

It may be seen from Table 1 that when the modified maleimide resin has a structure in which the main chain includes dicyclopentadiene (Example 1), the modified maleimide resin has good heat resistance, peel resistance, moisture resistance and dielectric properties at the same time.

In addition, compared to the maleimide resin (Comparative example 1) in which the main chain does not have a dicyclopentadiene structure, the modified maleimide resin (Example 1) in which the main chain has a dicyclopentadiene structure has greater glass transition temperature, greater peel strength, smaller water absorption, smaller dielectric constant and smaller dissipation factor, that is, better heat resistance, peel resistance, moisture resistance and dielectric properties.

Based on the above, the modified maleimide resin of the invention has a structure in which the main chain includes dicyclopentadiene, so it has good heat resistance, peel resistance, moisture resistance and dielectric properties. Therefore, the modified maleimide resin has good applicability.

Although the invention has been disclosed in the embodiments above, they are not intended to limit the invention. Anyone with ordinary knowledge in the relevant technical field can make changes and modifications without departing from the spirit and scope of the invention. The scope of protection of the invention shall be subject to those defined by the claims attached.

What is claimed is:

1. A modified maleimide resin, formed from a dicyclopentadiene-based resin having an amino group and a maleic anhydride by a condensation polymerization,
wherein the dicyclopentadiene-based resin having an amino group is formed by nitration and hydrogenation of dicyclopentadiene phenolic resin.

2. The modified maleimide resin according to claim 1, an equivalent ratio of a mole number of an amino group of the dicyclopentadiene-based resin having an amino group to a mole number of a maleic anhydride group of the maleic anhydride is 1:1 to 1:10.

3. The modified maleimide resin according to claim 1, a weight average molecular weight thereof is 800 to 10,000.

4. A modified maleimide resin, having a structure represented by Formula (1) as follows: 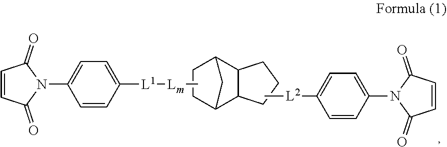
in Formula (1), L represents a dicyclopentadienylene group, a divalent organic group derived from a phenol-based compound or a combination thereof,
L¹ and L² each represent a divalent organic group derived from a phenol-based compound, and
m represents an integer from 0 to 18.

5. The modified maleimide resin according to claim 4, wherein the phenol-based compound includes phenol.

6. The modified maleimide resin according to claim 4, wherein L represents 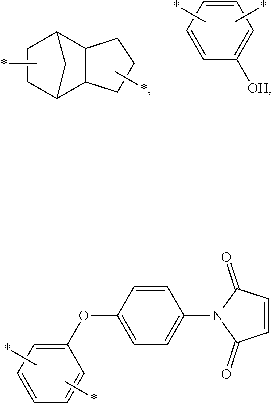
or a combination thereof, and * represents a bonding position.

7. The modified maleimide resin according to claim 4, wherein L¹ and L² each represent 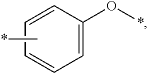
and * represents a bonding position.

8. The modified maleimide resin according to claim 4, a weight average molecular weight thereof is 800 to 10,000.
